(19) United States
(12) Patent Application Publication
(10) Pub. No.: US 2003/0202009 A1
(43) Pub. Date: Oct. 30, 2003

(54) Integration toolbar

(76) Inventor: Stephane Kasriel, San Francisco, CA (US)

Correspondence Address: ROBERT M. MCDERMOTT, ESQ., 1824 FEDERAL FARM ROAD, MONTROSS, VA, 22520, US

(21) Appl. No.: 10/351,875

(22) Filed: Jan. 27, 2003

Related U.S. Application Data
(60) Provisional application No. 60/375,165, filed on Apr. 24, 2002.

(51) Int. Cl. G09G 5/00

(52) U.S. Cl. 345/739; 345/810

(57) ABSTRACT

A web-page based integration toolbar provides the context within which other information or applications are accessed. A toolbar on a user's display is coupled to the currently displayed web-page, and provides contextual links to databases and applications based on the information currently displayed, or currently selected by the user. For example, the toolbar may contain a link to an inventory-control program, and may be configured to display of current inventory status of an item when the user selects the item on the user's displayed web-page. At the same time, the toolbar may contain a link to an analysis application that provides a demographic profile of prior purchasers of the selected item, and/or provides a forecast of likely demand, based on seasonal factors and the like. By providing a toolbar that is configured to provide contextual information to one or more independent databases or applications, based on the context of the page that a user is currently viewing, these independent databases and applications can be easily and efficiently integrated using a common user interface that is relatively easy to comprehend

This application claims the benefit of U.S. provisional application No. 60/375,165, filed Apr. 24, 2002.

### BACKGROUND OF THE INVENTION

1. Field of the Invention

This invention relates to the field of computer systems, and in particular to a web-page based interface that facilitates the integration of information from diverse sources.

2. Description of Related Art

The Internet provides a means to access information from innumerable sources. An online vendor has access to statistics related to the demographics of purchasers of each of the vendor's products or classes of products, as well as the demographics of non-purchasers, such as people who have visited the vendor's web-site, but left without a purchase. This on-line vendor also has access to warehousing programs that identify the current inventory level, the expected turn-around time for replenishment, average demand rate, and so on. The vendor may also have access to a wholesaler's database, to determine available stock, place an on-line order, identify similar items, available upgrades, and so on. If the online vendor also maintains offline sales outlets, the vendor may use an analysis of current web-activity to anticipate future demand for a product, and to influence the advertising strategy and inventory management of the individual outlet stores, depending, for example, on the geographic distribution of visitors to the web-site.

In the technical field, a web-site designer may use a web publishing service to effect desired changes to particular pages of the web-site. The desired changes may be based on web-page traffic analysis, or based on sales data for particular products, and so on. Similarly, the designer may monitor a variety of publications that include product reviews, and may modify the focus of a web-page, or emphasis provided to a particular product, accordingly. To control and manage the changes to a web-site, a web-site provider may use revision control software to coordinate the activities of multiple designers. The web-site provider may also use Internet-analysis services to assess the efficiency of the provider's web-site, and to influence the purchase of additional resources to improve the efficiency.

Conventionally, a user that has potential access to multiple databases or applications accesses each of the databases or applications independently. The user accesses each select database or application at a particular URL address, and then provides the information required by that database or application to access a particular item in the database, or to perform a particular analysis. Further complicating the process, because each of the accesses are independent of each other, the accesses are non-contextual, and often require that the user explicitly provide a variety of information related to the task at hand. In the examples above, product-information databases or applications are often based on a product's SKU, web-page analysis databases or applications are typically based on the page's URL, manufacturer databases or applications are often based on product model numbers, and so on.

### BRIEF SUMMARY OF THE INVENTION

An object of this invention is to provide a method and system that facilitates contextual access to independent databases or applications. Another object of this invention is to provide a method and system that facilitates the integration of multiple independent databases or applications. Another object of this invention is to provide a method and system that facilitates access to multiple independent databases and applications via a convenient and intuitive user interface.

These objects, and others, are achieved by a web-page based integration toolbar. The web-page provides the context within which other information or applications are accessed. A toolbar on a user's display is coupled to the currently displayed web-page, and provides contextual links to databases and applications based on the information currently displayed, or currently selected by the user. For example, the toolbar may contain a link to an inventory-control program, and may be configured to display of current inventory status of an item when the user selects the item on the user's displayed web-page. At the same time, the toolbar may contain a link to an analysis application that provides a demographic profile of prior purchasers of the selected item, and/or provides a forecast of likely demand, based on seasonal factors and the like. By providing a toolbar that is configured to provide contextual information to one or more independent databases or applications, based on the context of the page that a user is currently viewing, these independent databases and applications can be easily and efficiently integrated using a common user interface that is relatively easy to comprehend.

### BRIEF DESCRIPTION OF THE DRAWINGS

The invention is explained in further detail, and by way of example, with reference to the accompanying drawings wherein:

FIG. 1 illustrates an example display of an integration toolbar that is coupled to a displayed web-page in accordance with this invention.

FIG. 2 illustrates an example block diagram of a toolbar system that facilitates the integration of multiple databases and applications in accordance with this invention.

Throughout the drawings, the same reference numerals indicate similar or corresponding features or functions.

### DETAILED DESCRIPTION OF THE INVENTION

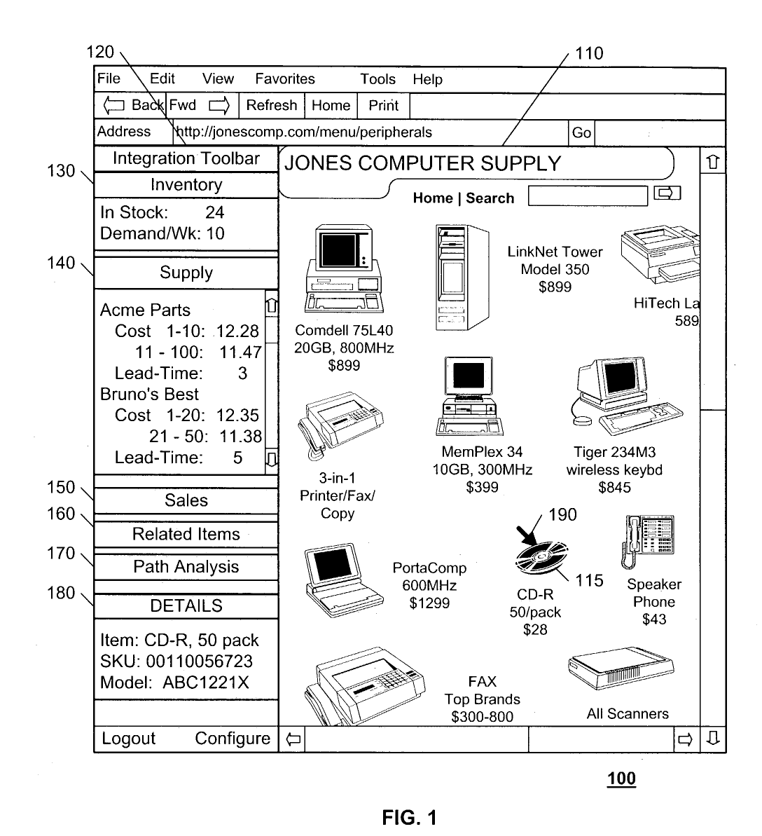

FIG. 1 illustrates an example display 100 of an integration toolbar 120 that is coupled to a displayed web-page 110 in accordance with this invention. The example toolbar 120 includes links to a variety of independent applications, such as applications that address inventory 130, supply 140, sales-analysis 150, related-analysis 160, path-analysis 170, and so on. For ease of reference, the term application hereinafter includes database access utilities as well as data processing and other utilities.

In accordance with this invention, the integration toolbar 120 has access to information based on a user's browser activities. The web-page 110 provides a context within which the applications of the toolbar 120 operate. Generally, the user is typically a person associated with the web-page 110, such as an employee of the company that provides the web-page 110. Assuming that the web-pages that the company provides includes all of the products that the company sells, for example, the company's supply manager may configure the integration toolbar 120 to integrate each of the applications that the supply manager uses regularly.

In the example display 100, the user has selected an item 115 on the web-page 110 via a cursor 190. In response to this selection, the inventory application 130 displays the current number of items 115 in stock, as well as other information typically provided by an inventory-management system, such as the rate of demand for the item 115. Also in response to the selection of the item 115, the supply application provides a list of wholesale suppliers of the item 115, the cost of the item 115 from each supplier, and so on. As would be evident to one of ordinary skill in the art, the displayed information in the toolbar 110 may include hypertext items, so that, for example, the user can select a particular supplier to order a resupply of the item 115. In a preferred embodiment of this invention, as discussed further below, the integration toolbar 120 facilitates access to program code on one or more servers, and thus the range of complexity of the applications is virtually limitless. For example, an application may be provided via the toolbar 120 that updates the inventory database of the inventory application 130 upon placing an order to resupply the item 115 via the application 140. These and other schemes that facilitate the integration of heretofore independent applications will be evident to one of ordinary skill in the art in view of this disclosure.

In accordance with this invention, the integration toolbar 120 has access to information contained on the web-page 110, information from the browser regarding past and present user activities within the browser, and information from local and remote databases. Thus, the context of the web-page information can be based on a sequence of user choices, and the specific information can be based on one or more database mappings. For example, if the information on the web-page identifies an item by SKU, the integration toolbar 120 can be configured to access one or more databases to determine the item's corresponding manufacturer's model number, average selling price, and so on. In this manner, the integration toolbar 120 can effect an integration of applications that are configured to use different forms of information corresponding to the same item.

In accordance with a preferred embodiment of this invention, the integration toolbar 120 is embodied as a browser band object to effect the integration of multiple independent applications 130-170 with a displayed web-page 110. The band object 120 is synchronized with access to each selected web-page 110, via a browser or other program that accesses the page. The band object 120 notes which web-page the user is currently accessing, and concurrently accesses each of the selected applications 130-170 based upon the content and context of the accessed web-page 110.

Any of a variety of techniques may be applied to effect the concurrent rendering of the band object 120 with the web-page 110. In a typical browser, a band object 120 is allocated a region of the display space, typically a “side-bar” within the browser window, such as the “search” side-bar that appears within the browser window when a user selects the “search” option. In a straightforward embodiment of this invention, a list of accessible applications is displayed within the side-bar that is allocated to the band object 120. In a more complex embodiment, the accessible applications may be associated with a particular location or a particular object within the web-page 110, and may optionally be displayed as an overlay upon the displayed web-page, coincident with the associated location or object. The overlay may appear as a simple box, a note “bubble”, a “flag” item, or as an imitation of a physical entity, such as a Post-It® note, and so on. Also optionally, an icon may be displayed at the associated location or object, and the actual output from the application is displayed upon selection of the icon. These and other techniques for concurrently displaying related information from two sources will be evident to one of ordinary skill in the art in view of this disclosure

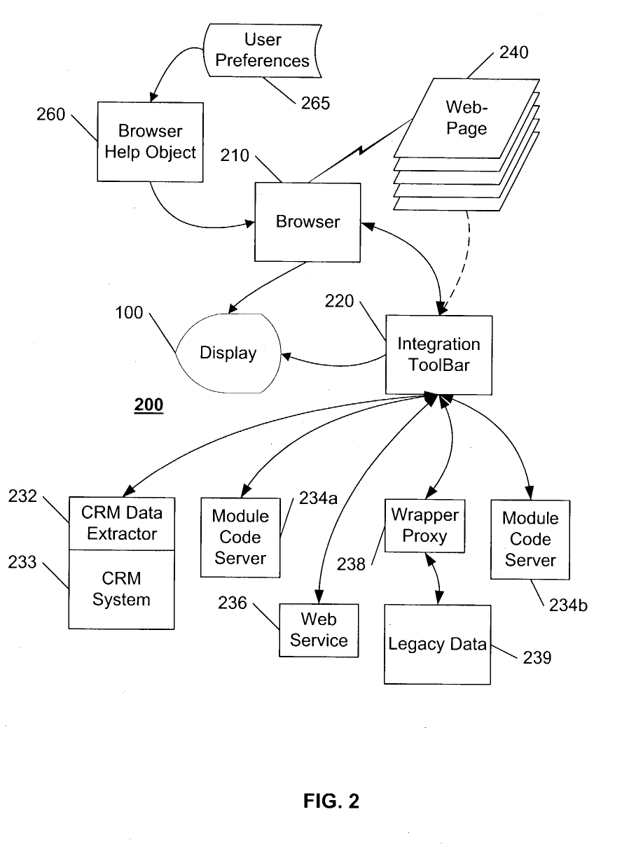

FIG. 2 illustrates an example block diagram of a toolbar system 200 that facilitates the integration of multiple applications in accordance with this invention. A user (not shown) accesses one or more web-pages 240, via a browser 210. An integration toolbar 220 monitors the transactions of the browser 210, to provide a context within which other applications 232-238 operate.

The integration toolbar 220 may access select applications 232 directly, by providing parameters to applications that provide a response based on the provided parameters, such as an inventory system that provides the number of items on hand given a particular item identifier. Alternatively, the toolbar 220 may access applications via one or more module code servers 234a, 234b that are configured to effect custom-designed code that effects a desired process and response based on the provided parameters. The toolbar 220 may also access a conventional web service 236, or a proxy interface 238 that is configured to access legacy databases 239.

In a preferred embodiment of this invention, the user is provided an editor that facilitates the creation of the toolbar 220. Within each web-page 240, the user places item-identifiers, typically in the form of a hypertext parameter, to identify select items on the web-page. These same identifiers are used within the toolbar 220 to identify the parameters that are passed to the applications 232-238. When an item on the web-page 240 is subsequently selected, the value of the item-identifier(s) associated with the selected item is set to correspond to the selected item, so that a subsequent call to an application 232-238 is effected using the assigned value(s). In this manner, the call to the application 232-238 is effected in the context of the user's navigation of the web-page 240 via the browser 210.

In a preferred embodiment of this invention, the applications that are available for access via the toolbar are defined in a configuration page that is specific to each user. Typically, a site administrator defines which data sources to make available to each user within an organization, and defines how each of the parameters are to be passed or retrieved from these data sources. Each user is provided the option to select particular applications of interest from the configuration page, and the toolbar will subsequently query and display only these selected applications.

Also illustrated in FIG. 2 is an optional browser help object 260 that is configured to facilitate the implementation of user preferences 265. In a typical browser environment, help objects are always invoked when the browser is started, whereas a band object is invoked only if it had been invoked when the browser was last exited. Other default behavior may also be associated with the initiation of the browser.

To facilitate custom control of the integration system 200, the browser help object 260 of this invention accesses the user preferences 265 and subsequently issues commands to the browser 210 to effect these preferences 265, independent of the default behavior of the browser 210. For example, a user may prefer that the band object 220 is always invoked, or never invoked, when the browser 210 is started, independent of whether the band object 220 had been invoked when the browser 210 was last exited. Similarly, the user may prefer that the band object 220 be invoked under certain circumstances, but not others. For example, the user may choose to invoke the band object 220 whenever the user is browsing a particular web-site, or web-page, and to disable the band object 220 whenever the user traverses to another web-site. Other customizing features will be evident to one of ordinary skill in the art in view of this disclosure, as will other techniques for enabling user preferences and customization.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A toolbar system comprising:
a web-page access system that is configured to allow a user to navigate through a plurality of web-pages and to display a select web-page,
a toolbar, operably coupled to the web-page access system, that is configured to:
obtain context information based on the select web-page, and
provide some or all of the context information to one or more applications that are substantially independent of the select web-page.

2. The toolbar system of claim 1, wherein
the toolbar is further configured to
receive resultant information from the one or more applications in response to receipt of the some or all of the context information, and
provide the resultant information to the user.

3. The toolbar system of claim 1, wherein
each of the one or more applications is substantially independent of each other of the one or more applications.

4. The toolbar system of claim 1, wherein
the context information is further based on a select item on the select web-page.

5. The toolbar system of claim 4, wherein
the one or more applications include at least one of:
a database-access application,
an inventory-control application,
a traffic-analysis application,
a sales-automation application, and
a customer-profile application.

6. The toolbar system of claim 4, wherein
the context information includes at least one of:
an SKU of the select item,
a model number of the select item,
a URL of the select web-page, and
a supplier identification.

7. The toolbar system of claim 1, wherein
the one or more applications include at least one of:
a database-access application,
a software-management application,
an inventory-control application,
a traffic-analysis application,
a sales-automation application, and
a customer-profile.

8. A method of integrating a plurality of applications, comprising:
providing a toolbar system for inclusion in a network browser,
the toolbar system being configured to obtain context information from a web-page that is displayed by the network browser, and
providing an editor that is configured to facilitate programming of the toolbar system to convey some or all of the context information to each of the plurality of applications.

9. The method of claim 8, further including
providing a rendering system that is configured to render received information from the plurality of applications.

10. The method of claim 8, wherein
each of the plurality of applications is substantially independent of each other of the plurality of applications.

11. The method of claim 8, wherein
the context information is further based on a select item on the web-page.

12. The method of claim 11, wherein
the plurality of applications include at least one of:
a database-access application,
an inventory-control application,
a traffic-analysis application,
a sales-automation application, and
a customer-profile application.

13. The method of claim 11, wherein
the context information includes at least one of:
an SKU of the select item,
a model number of the select item,
a URL of the select web-page, and
a supplier identification.

14. The method of claim 8, wherein
the one or more applications include at least one of:
a database-access application,
a software-management application,
an inventory-control application,
a traffic-analysis application,
a sales-automation application, and
a customer-profile.

15. A computer program that is configured for execution on a computer system, so as to cause the computer system to:
display a toolbar that is operably coupled to a web-page access system that is configured to display a select web-page,
obtain context information from the select web-page, and
communicate the context information from the select web-page to one or more applications identified by the toolbar.

16. The computer program of claim 15, wherein the computer program is configured to further cause the computer system to:
receive resultant information from the one or more applications in response to receipt of the context information, and
display some or all of the resultant information.

17. The computer program of claim 15, wherein
each of the one or more applications is substantially independent of each other of the one or more applications.

18. The computer program of claim 15, wherein
the context information is further based on a select item on the select web-page.

19. The computer program of claim 15, wherein
the one or more applications include at least one of:
a database-access application,
an inventory-control application,
a traffic-analysis application,
a sales-automation application, and
a customer-profile application.

20. The computer program of claim 15, wherein
the context information includes at least one of:
an SKU of the select item,
a model number of the select item,
a URL of the select web-page, and
a supplier identification.
